(19) United States
(12) Patent Application Publication
(10) Pub. No.: US 2014/0007372 A1
(43) Pub. Date: Jan. 9, 2014

(54) CLEANING DEVICE

(71) Applicant: Wen-da Cheng, Shenzhen (CN)

(72) Inventor: Wen-da Cheng, Shenzhen (CN)

(73) Assignee: Shenzhen China Star Optoelectronics Technology Co. Ltd., Shenzhen (CN)

(21) Appl. No.: 13/807,188

(22) PCT Filed: Aug. 14, 2012
(86) PCT No.: PCT/CN12/80107

§ 371 Date: Dec. 27, 2012

(30) Foreign Application Priority Data
Jul. 9, 2012 (CN) 201220329512.9

(51) Int. Cl. B08B 5/02; B08B 5/04

(52) U.S. Cl. CPC B08B 5/02; B08B 5/04
USPC 15/345

(57) ABSTRACT

A cleaning device includes a suction pipe and a number of blowing pipes surrounding the suction pipe. Each of the blowing pipes is noncoplanar with the suction pipe and includes a blowing opening inclined toward the suction pipe. With the cleaning device of the present disclosure, the impurities on the array substrate can be removed in the array fabricating process, therefore, when the data liens or scan lines on the array substrate are coated, the coating material can be prevented from dropping off in the following cleaning process, which improves the success rate of coating the disconnected lines.

### BACKGROUND

1. Technical Field

The present disclosure relates to technologies of liquid crystal panels and, particularly, to a cleaning device used in fabricating process of an array substrate.

2. Description of Related Art

Liquid Crystal Display (LCD) is a Flat Panel Display (FPD) that uses the characteristics of liquid crystal to display image. Compared to other types of display, LCD is thin and it requires lower driving voltage and lower power consumption, which makes it the mainstream product in the consumer goods market.

Liquid crystal panel is the main component of the LCD. The process for fabricating the liquid crystal panel mainly includes an earlier array process, a middle cell process, and a later module process. The earlier array process specifically includes: depositing a film layer on a substrate, coating photoresist on the film layer and carrying out exposing process, developing process, etching process, and photoresist stripping process to form scan lines, a semi-conductor layer, data lines, a protective layer, a transparent conductive layer, etc.

In the array fabricating process, the scan lines and data lines may be short or disconnected due to various factors. Therefore, after the array fabricating process is finished, the array substrate is detected to determine whether there are disconnected defects or/and short defects in data lines and scan lines. If there are disconnected defects or/and short defects in data lines or scan lines, a repairing device is used for repairing the disconnected and/or short data lines or scan lines. When there is disconnected defect, the repairing device at first removes the object covering two terminals of the disconnected line, such as the semi-conductor layer, and then the repairing device disposes a repair line to connect the two terminals of the disconnected line to form a passageway.

However, when the repairing device is removing the object covering the two terminals of the disconnected line, the object may be carbonized to produce impurities. Additionally, when the repairing device is disposing the repair line, other impurities may be produced in other fabricating processes may be remained on the array substrate. If there is impurity under the repair line, the repair line may drop off in cleaning processes after the repair device disposed the repair line, and thus reduces the success rate of coating the disconnected lines.

### SUMMARY

The present disclosure provides a cleaning device, including a suction pipe and a number of blowing pipes surrounding the suction pipe. Each of the blowing pipes is noncoplanar with the suction pipe and includes a blowing opening inclined toward the suction pipe.

Preferably, the cleaning device further includes a housing; the suction pipe and the blowing pipes are all disposed on a lower surface of the housing, the suction pipe is perpendicular to the housing, and each blowing pipe and the lower surface of the housing forms an angle within a range from 30 degrees to 60 degrees.

Preferably, the suction pipe has a suction opening, and a distance between each blowing opening and the housing is greater than a distance between the suction opening and the housing.

Preferably, the suction pipe has a suction opening, and an area surrounded by each blowing opening is less than or equal to an area of the suction opening.

Preferably, the angle formed between the blowing pipe and the lower surface of the housing is 45 degrees.

Preferably, the cleaning device further includes a controller connected to the blowing pipes for controlling each blowing opening, to incline towards the suction pipe.

Preferably, the cleaning device further includes a housing, the housing has a lower surface, the suction pipe is disposed in a center portion of the housing and runs through the lower surface; the blowing pipes are disposed inside the housing and run through the lower surface, and each blowing pipe and the lower surface forms an angle ranging from 30 degrees to 60 degrees.

Preferably, a guiding ring is disposed on an edge of each blowing opening.

Preferably, the angle formed between each blowing pipe and the lower surface of the housing is 45 degrees.

The present disclosure further provides another cleaning device. The cleaning device includes a suction pipe and a number of blowing pipes surrounding the suction pipe. Each of the blowing pipes is inclined relative to the suction pipe and is noncoplanar with the suction pipe.

Preferably, the cleaning device further includes a housing, the suction pipe and the blowing pipes are all disposed on a lower surface of the housing; the suction pipe is perpendicular to the housing, and each blowing pipe and the lower surface of the housing forms an angle ranging from 30 degrees to 60 degrees.

Preferably, the angle formed between each blowing pipe and the lower surface of the housing is 45 degrees.

Preferably, the suction pipe includes a suction opening, each blowing pipe has a blowing opening, and the distance between each blowing opening and the housing is greater than the distance between the suction opening and the housing.

Preferably, the suction pipe includes a suction opening, each blowing pipe has a blowing opening, and an area surrounded by each blowing opening is less than an area of the suction opening.

Preferably, the cleaning device further includes a controller connected to the blowing pipes for controlling the blowing openings to move towards the suction pipe.

Preferably, the cleaning device further includes a housing having a lower surface, the suction pipe is disposed in a center portion of the housing and runs through the lower surface; the blowing pipes are disposed inside the housing and run through the lower surface of the housing; and each blowing pipe and the lower surface of the housing forms an angle ranging from 30 degrees to 60 degrees.

Preferably, the angle formed between each blowing pipe and the lower surface of the housing is 45 degrees.

Preferably, each blowing pipe has a blowing opening, and a guiding ring is disposed on an edge of the blowing opening.

Preferably, the cleaning device further includes a blowing device communicating with the blowing pipes, a suction device communicating with the suction pipe, and a controller for controlling the blowing device and the suction device, and the controller is connected to the blowing device and the suction device.

With the cleaning device of the present disclosure, the impurities on the array substrate can be removed in the array fabricating process, therefore, when the data liens or scan lines on the array substrate are coated, the coating material can be prevented from dropping off the disconnected lines in the following cleaning process, which improves the success rate of coating the disconnected lines.

### DESCRIPTION OF THE DRAWINGS

Many aspects of the embodiments can be better understood with reference to the following drawings. The components in the drawings are not necessarily drawns to scale, the emphasis instead being placed upon clearly illustrating the principles of the embodiments. Moreover, in the drawings, like reference numerals designate corresponding parts throughout the several views.

FIG. 1 is a schematic view of a cleaning device in accordance with a first embodiment of the present disclosure;

FIG. 2 is a front view of the cleaning device of FIG. 1;

FIG. 3 is a bottom view of the cleaning device of FIG. 1;

FIG. 4 is a schematic view of a cleaning device in accordance with a second embodiment of the present disclosure;

FIG. 5 is a schematic view of a cleaning device in accordance with a third embodiment of the present disclosure;

FIG. 6 is a bottom view of the cleaning device of FIG. 5;

FIG. 7 is a cross-sectional view of the cleaning device of FIG. 6 taken along the line A-A.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

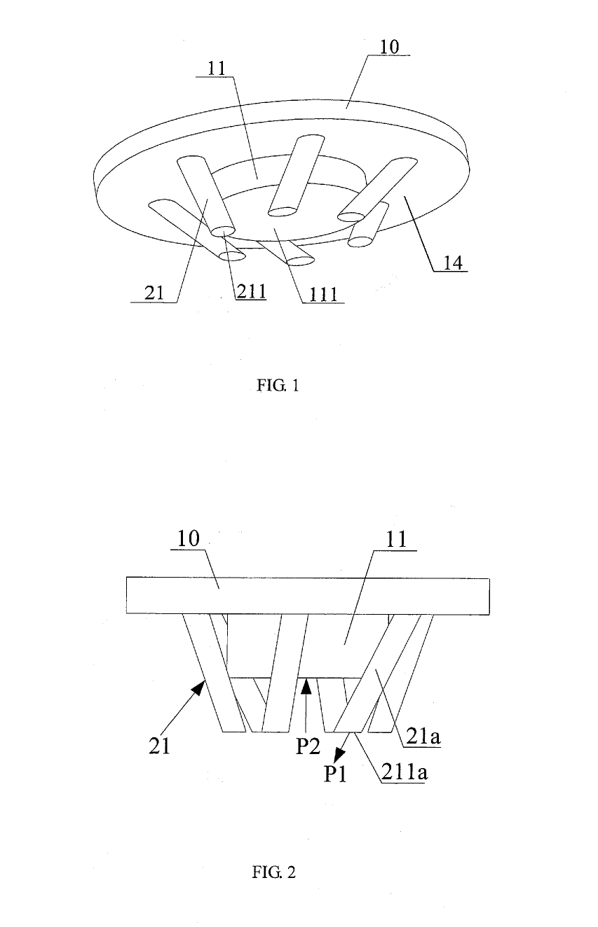

Referring to FIG. 1, a cleaning device in accordance with a first embodiment of the present disclosure is schematically shown. In the embodiment, the cleaning device is placed above an array substrate for removing impurities remained on the array substrate. In other embodiments, the cleaning device can be used for removing impurities on other objects. The cleaning device includes a housing 10 having a lower surface 14. A suction pipe 11 and a number of blowing pipes 21 surrounding the suction pipe 11 are arranged on the lower surface 14 of the housing 10. Each blowing pipe 21 is inclined relative to the suction pipe 11 and is noncoplanar with the suction pipe 11.

Since the blowing pipes 21 surround the suction pipe 11, and each blowing pipe 21 is inclined relative to the suction pipe 11 and is noncoplanar with the suction pipe 11, therefore, after the cleaning device is disposed above the array substrate and is spaced away from the array substrate for an appropriate distance, gas flows blown from the blowing pipes 21 are capable of blowing the impurities up, which allows the impurities to flow as the gas flow and be sucked into the housing 10 through the suction pipe 11. In this way, the impurities on the array substrate can be removed by the cleaning device.

With the above cleaning device of the present disclosure, the impurities on the array substrate can be removed in the array fabricating process, which prevents repair lines disposed on the array substrate for connecting the disconnected lines from dropping off in following fabricating processes, for example, in a cleaning process. In this way, the success rate of repairing the disconnected lines can be improved.

Furthermore, the suction pipe 11 is perpendicular to the housing 10 and has a suction opening 111. Each blowing pipe 21 has a blowing opening 211 which is inclined towards the suction pipe 11. Each blowing pipe 21 and the lower surface 14 of the housing 10 form an angle within a range from 30 degrees to 60 degrees. Preferably, the angle formed therebetween is 45 degrees.

Specifically, referring to FIG. 2, which is a front view of the cleaning device. Take a blowing pipe 21i a as an example, the direction of the gas flow blown therefrom is shown as P1 and the direction of the gas flow sucked into the suction pipe 11 is shown as P2; neither the direction P2 intersects with the direction P1, nor the direction P2 is parallel with the direction P1. That is, the direction P2 is noncoplanar with the direction P1. Meanwhile, the blowing opening 211a of the blowing pipe 21a is inclined towards the suction pipe 11. The other blowing pipes 21 are configured by referring to the blowing pipe 21a described above, which is not given in detail.

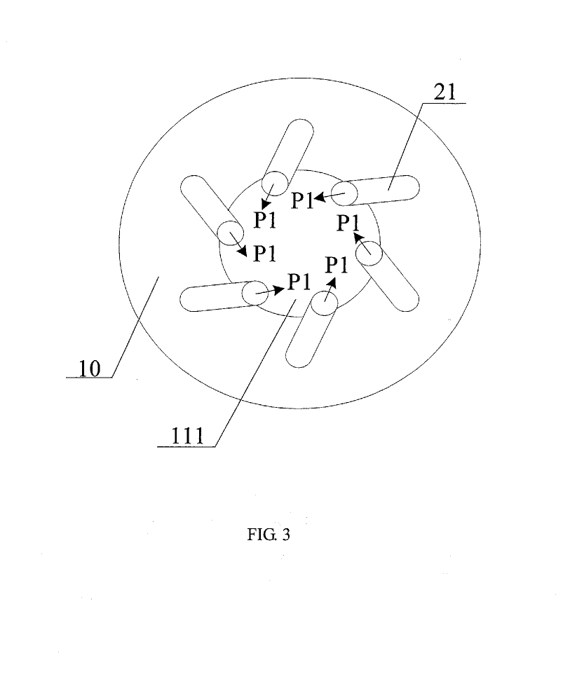

Referring to FIG. 3, which is a bottom view of the cleaning device. With the above configurations of the blowing pipes 21, the gas flow from the blowing openings 211 whirls counterclockwise to blow the impurities up from the array substrate. Since the pressure in the suction pipe 11 is lower than the atmosphere pressure, thus, the impurities blown up by the gas flown from the blowing pipes 21 can be sucked into the suction pipe 11 through the suction opening 111.

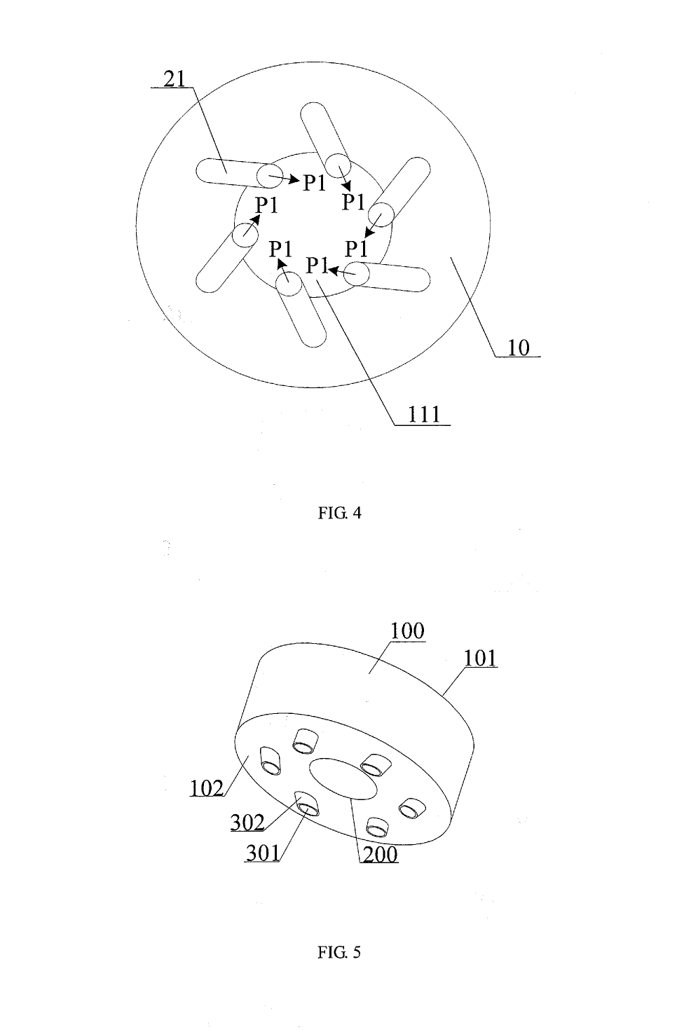

Referring to FIG. 4, a cleaning device, in accordance with a second embodiment is schematically shown. All the blowing pipes 21 of the cleaning device of the second embodiment are also inclined relative to the housing 10. The inclined direction of each blowing pipe 21 relative to the housing 10 of the second embodiment is symmetric to the inclined direction of each blowing pipe 21 relative to the housing 10 of the first embodiment about the radial direction of the housing 10, therefore, the gas flow blown from all the blowing pipes 21 whirls clockwise.

Furthermore, the cleaning device of the second embodiment further includes a blowing device and a suction device (not shown in the drawings) respectively communicates with the suction pipe 11 and the blowing pipes 21.

Specifically, the suction device and the blowing device can be disposed inside or outside the housing 10 and can be disposed independently. For example, the blowing device mainly includes a blower which is capable of rotating at high speed to blow the inert gas out from the blowing device through the blowing pipes 21. The suction device includes a suction fan which is capable of rotating at high speed and lowering the air pressure in the suction pipe 11 to be lower than the atmosphere pressure, which consequently sucks the air into the suction device from outside through the suction pipe 11. At this time, impurities on the substrate such as residues and particles are sucked into the suction device as the gas flow. Additionally, the suction device can further include a filtering device for filtering the gas sucked into the suction pipe. The gas sucked into the suction device passes through the filtering device to filter the impurities before blowing out from the blower.

It is understood that the passageways of the suction device and the blowing device can be communicated with each other, that is, the gas flow sucked into the suction device through the suction pipe 11 can further be blown out of the blowing device after passing through the filtering device.

Furthermore, the cleaning device further includes a controller (not shown in the drawing) connected to the blowing device and the suction device for respectively controlling the blowing device and the suction device. Correspondingly, the controller can be disposed inside or outside the housing 10.

Specifically, the controller is capable of controlling the blowing device to work for a predetermined period and then control the suction device to work. Thus, the suction device is capable of sucking the impurities on the array substrate through the suction opening 111 of the suction pipe 11 after the gas flow blown from the blowing pipe 21 whirls the impurities up from the array substrate, thereby improving the efficiency of the cleaning device.

Furthermore, the controller can also be connected to each blowing pipe 21 for controlling each blowing opening 211 to move towards the suction pipe 11. Specifically, the controller controls each blowing opening 211 to move towards the suction pipe 11 when controlling the blowing pipe 21 to blow the gas flow out. In this way, the impurities on the array substrate can gather around the suction pipe 11, allowing the suction pipe 11 to suck the impurities more efficiently. With the controller, not only the success rate of the operation of removing the impurities can be improved, but also the energy consumption is reduced.

Furthermore, the distance between the each blowing opening 211 and the housing 10 is greater than the distance between the suction opening 111 and the housing 10. Preferably, the area surrounded by the blowing openings 211 is less than or equal to the area of the suction opening 111. After the cleaning device is disposed above the array substrate, the gas flow blown from the blowing pipes 21 can be sucked into the suction pipe 11 with the above configurations of the suction pipe 11 and the blowing pipes 21, which improves the efficiency of the operation of removing the impurities from the array substrate.

Furthermore, the cleaning device includes even-numbered blowing pipes 21 which are symmetrically arranged about the suction pipe 11.

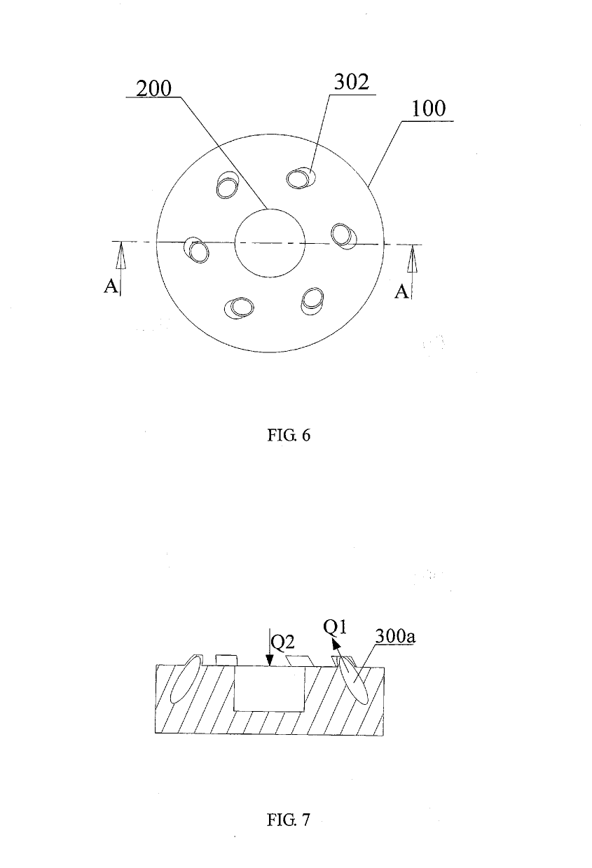

Referring to FIGS. 5 to 7, in which FIG. 5 is a schematic view of a cleaning device of a third embodiment, FIG. 6 is a bottom view of the cleaning device of the third embodiment, and FIG. 7 is a cross-sectional view of the cleaning device taken along the line A-A. The cleaning device of the third embodiment includes a cylindrical housing 100 having an upper surface 101 and a lower surface 102. A suction pipe 200 is disposed in a center portion of the housing 100 and runs through the lower surface 102 of the housing 100. A number of blowing pipes 300 are disposed in the housing 100, surrounding the suction pipe 200 and running through the lower surface 102.

The suction pipe 200 is perpendicular to the lower surface 102 of the housing 100. The suction pipe 200 includes a suction opening 201. Each blowing pipe 300 includes a blowing opening 301 inclined towards the suction pipe 200. The angle formed between each blowing pipe 300 and the lower surface 102 of the housing 100 ranges from 30 degrees to 60 degrees, preferably 45 degrees.

Take a blowing pipe 300a as an example, the direction of the gas flow blown from of the blowing pipe 300a is shown as Q1 and the direction of the gas flow sucked into the suction pipe 200 is shown as Q2. Neither the direction Q1 intersects with the direction Q2, nor the direction Q1 is parallel with the direction Q2. That is, the direction Q2 is noncoplanar with the direction Q1. Meanwhile, the blowing opening 301a of the blowing pipe 300a is inclined towards the suction pipe 200. The configurations of the other blowing pipes 300 are the same as that of the blowing pipe 300a, which is not given in detail.

In the above embodiment, the gas flow blown from the blowing openings 301 of the blowing pipes 300 whirls counter-clockwise. The gas flow continuously whirls up to be sucked into the suction pipe 200 through the suction opening 201. It is understood that if the inclined direction of each blowing pipe 300 relative to the housing 100 of other embodiments is symmetric to the inclined direction of each blowing pipe 300 relative to the housing 100 of the third embodiment about the radial direction of the housing 100, the gas flow blown from the blowing pipe 300 will whirl clockwise.

Furthermore, the cleaning device of the third embodiment further includes a blowing device and a suction device (not shown in the drawings) respectively communicating with the suction pipe 200 and the blowing pipes 300.

Specifically, the suction device and the blowing device can be disposed inside or outside the housing 100 and can be disposed independently. For example, the blowing device mainly includes a blower capable of rotating at high speed to blow the inert gas out from the blowing device through the blowing pipes 300. The suction device includes a suction fan which is capable of rotating at high speed to lower the air pressure in the suction pipe 200 than the atmosphere pressure, thereby sucking the air into the suction device from outside through the suction pipe 200.

It is understood that the suction device and the blowing device can be integrated into one device. For example, a passageway of the suction device communicates with the passageway of the blowing device, thus, the inert gas can be sucked into the suction device and further blown out from the blowing device through the blowing pipes 300 after passing through the blower thereof.

Furthermore, the cleaning device further includes a controller connected to the blowing device and the suction device for respectively controlling the blowing device and the suction device.

Specifically, the controller is capable of controlling the blowing device to work for a predetermined period and then control the suction device to work. Thus, the suction opening 201 of the suction pipe 200 is capable of sucking the inert gas blown from of the blowing pipe 300 more efficiently after the gas flow whirls upwards.

A guiding ring 302 is disposed on an edge of the blowing opening 301 of each blowing pipe 300. When the cleaning device is at work, the gas flows blown from the blowing pipes 300 gather from outside to inside after passing through the guiding ring 302, which whirls the impurities up from the array substrate to be sucked into the suction device through the suction pipe 200 and thus removes the impurities.

Furthermore, the repairing device includes even-numbered blowing pipes 300 which are symmetrically disposed about the suction pipe 200.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A cleaning device comprising:
a suction pipe; and
a plurality of blowing pipes surrounding the suction pipe and being noncoplanar with the suction pipe, each of the blowing pipes comprising a blowing opening inclined toward the suction pipe.

2. The cleaning device as claimed in claim 1 further comprising a housing; the suction pipe and the blowing pipes are all disposed on a lower surface of the housing, the suction pipe is perpendicular to the housing, and each blowing pipe and the lower surface of the housing forms an angle within a range from 30 degrees to 60 degrees.

3. The cleaning device as claimed in claim 2, wherein the suction pipe has a suction opening, and a distance between each blowing opening and the housing is greater than a distance between the suction opening and the housing.

4. The cleaning device as claimed in claim 2, wherein the suction pipe has a suction opening, and an area surrounded by each blowing opening is less than or equal to an area of the suction opening.

5. The cleaning device as claimed in claim 2, wherein the angle formed between the blowing pipe and the lower surface of the housing is 45 degrees.

6. The cleaning device as claimed in claim 2 further comprising a controller connected to the blowing pipes for controlling each blowing opening to incline towards the suction pipe.

7. The cleaning device as claimed in claim 1 further comprising a housing, the housing has a lower surface, the suction pipe is disposed in a center portion of the housing and runs through the lower surface; the blowing pipes are disposed inside the housing and run through the lower surface, and each blowing pipe and the lower surface forms an angle ranging from 30 degrees to 60 degrees.

8. The cleaning device as claimed in claim 7, wherein a guiding ring is disposed on an edge of each blowing opening.

9. The cleaning device as claimed in claim 7, wherein the angle formed between each blowing pipe and the lower surface of the housing is 45 degrees.

10. A cleaning device, comprising:
a suction pipe; and
a plurality of blowing pipes surrounding the suction pipe, each of the blowing pipes being inclined relative to the suction pipe and being noncoplanar with the suction pipe.

11. The cleaning device as claimed in claim 10 further comprising a housing, the suction pipe and the blowing pipes are all disposed on a lower surface of the housing; the suction pipe is perpendicular to the housing, and each blowing pipe and the lower surface of the housing forms an angle ranging from 30 degrees to 60 degrees.

12. The cleaning device as claimed in claim 11, wherein the angle formed between each blowing pipe and the lower surface of the housing is 45 degrees.

13. The cleaning device as claimed in claim 11, wherein the suction pipe comprises a suction opening, each blowing pipe has a blowing opening, and the distance between each blowing opening and the housing is greater than the distance between the suction opening and the housing.

14. The cleaning device as claimed in claim 11, wherein the suction pipe comprises a suction opening, each blowing pipe has a blowing opening, and an area surrounded by each blowing opening is less than an area of the suction opening.

15. The cleaning device as claimed in claim 14 further comprising a controller connected to the blowing pipes for controlling the blowing openings to move towards the suction pipe.

16. The cleaning device as claimed in claim 10 further comprising a housing having a lower surface, the suction pipe is disposed in a center portion of the housing and runs through the lower surface; the blowing pipes are disposed inside the housing and run through the lower surface of the housing; and each blowing pipe and the lower surface of the housing forms an angle ranging from 30 degrees to 60 degrees.

17. The cleaning device as claimed in claim 16, wherein the angle formed between each blowing pipe and the lower surface of the housing is 45 degrees.

18. The cleaning device as claimed in claim 16, wherein each blowing pipe has a blowing opening, and a guiding ring is disposed on an edge of the blowing opening.

19. The cleaning device as claimed in claim 16 further comprising a blowing device communicating with the blowing pipes, a suction device communicating with the suction pipe, and a controller for controlling the blowing device and the suction device, and the controller is connected to the blowing device and the suction device.
